(19) United States
(12) Patent Application Publication
(10) Pub. No.: US 2010/0187726 A1
(43) Pub. Date: Jul. 29, 2010

(54) Stabilized rotomolded parts

(75) Inventors: Ian Robert Gibbons, Calgary (CA); Tony Tikuisis, Calgary (CA)

Correspondence Address: Kenneth H. Johnson;Patent Attorney, P.O. Box 630708, Houston, TX, 77263, US

(73) Assignee: NOVA CHEMICALS (INTERNATIONAL) S.A

(21) Appl. No.: 12/657,163

(22) Filed: Jan. 14, 2010

(30) Foreign Application Priority Data
Jan. 29, 2009 (CA) 2,651,514

(51) Int. Cl. B29C 41/04

(52) U.S. Cl. 264/310

(57) ABSTRACT

Easy processing rotomolding resins which have a high melt index, I₂, (as measured by ASTM D 1238) of from 2 to 10 (especially 3 to 8) grams/10 minutes and a narrow molecular weight distribution, Mw/Mn, of from 2.0 to 3.0 are difficult to stabilize with correctional additive packages. The present invention resolves this problem by the use of from 500 to 5000 parts per million by weight (ppm) of zinc oxide, in addition to a standard stabilizer additive package.

### FIELD OF THE INVENTION

This invention relates to a rotomolding process which employs an easily processable polyethylene resin and a specific additive package.

### BACKGROUND OF THE INVENTION

Rotational molding, also known as rotomolding, is a well known process which is widely used to produce hollow plastic parts such as gasoline containers, garbage cans, agricultural storage vessels, septic tanks and sporting goods such as kayaks. The process is undertaken by loading a charge of finely divided plastic resin into the mold “shell”, then rotating the mold (usually, on two axes) while heating it to a temperature above the melting point of the plastic resin. The melted plastic flows through the mold cavity under the forces caused by the rotation of the apparatus. The rotation continues for sufficient time to allow the molten plastic to cover the surface of the mold. The mold is then cooled to permit the plastic to freeze into a solid. The final stage of the molding cycle is the removal of the part from the rotomolding machine.

The time required to complete the molding cycle is a function of the bulk properties of the plastic which is being molded. For example, it is recognized by those skilled in the art that the plastic resin which is charged into the mold is preferably finely divided (i.e. ground into powder) and has a high bulk density and a narrow particle size distribution to facilitate the “free flow” of the resin.

It will also be appreciated that the physical properties of the rotomolded part are influenced by the use of a proper molding cycle time with “undercooked” parts having poor strength properties and “overcooked” parts suffering from poor appearance (a “burnt” color) and/or a deterioration of strength properties. It is desirable to have a short molding cycle (so as to improve the productivity of the expensive rotomolding machinery) and a broad “processing window” (i.e. the rotomolding composition ideally provides “properly cooked” parts in a short period of time but does not become “overcooked” for an extended period of time).

In addition, the properties of the rotomolded part are affected by the molecular structure of the polymer used to prepare the part. Physical properties of importance include stiffness (as indicated by the modulus of the part), environmental stress crack resistance (or “ESCR”), impact resistance and resistance to warpage.

Thermoplastic polyethylene copolymer is a commonly used plastic resin for the manufacture of rotomolded parts. Conventional polyethylene copolymer resin (which is generally prepared by the copolymerization of ethylene with a C_{4 to 10} alpha olefin in the presence of a chromium catalyst or a Ziegler Natta catalyst) is typically used. The alpha olefin comonomer produces “short chain branches” (SCB) in the copolymer. These SCB reduce the crystallinity of the copolymer (in comparison to a linear ethylene homopolymer) and the copolymers typically have improved impact resistance in comparison to homopolymers. These conventional polyethylenes may be referred to as “heterogeneous” in the sense that the polyethylene is actually a mixture of different polyethylene chains having significantly different molecular weights and comonomer distributions. Most notably, a conventional heterogeneous polyethylene copolymer resin generally contains three fractions:

i) a low molecular weight fraction having a high comonomer content (or high level of SCB)—this fraction is often referred to as “wax” or “extractables”;

ii) a very high molecular weight fraction having essentially no comonomer—this fraction is often referred to as “homopolymer”; and

iii) a fraction of intermediate molecular weight and SCB content.

These conventional polyethylenes are well suited for rotomolding. For example, whilst not wishing to be bound by theory, it has been postulated that the high molecular weight “homopolymer” fraction may enhance the stiffness or modulus of the rotomolded parts. However, as may be expected, the physical properties of a finished part (which has been molded with a proper cycle time) are largely “set” by the molecular structure of the polyethylene copolymer used to prepare the part. This, in turn, often results in finished parts with a suboptimal balance of properties.

More recently, homogeneous ethylene copolymers have become commercially available. These homogenous polymers have a uniform (or narrow) molecular weight distribution and a uniform comonomer distribution. This, in turn, causes the homogeneous copolymers to have a well defined melting point (in comparison to the heterogeneous polymers which have a melting point “range” or even multiple melting points).

The sharp melting point might have been expected to be advantageous for a rotomolding process. However, in practice, it has been found that parts prepared from a single homogeneous resin are prone to warpage and also generally have poor modulus or stiffness. Blends of homogeneous resins have been shown to mitigate this warpage problem, as disclosed in U.S. Pat. No. 7,201,864 (the disclosure of which is incorporated herein by reference).

A desire for rotomolding processes with even faster cycle times has led to the use of polymers having comparatively melt index, I₂, (as determined by ASTM D 1238 using a 2.16 kg weight). Melt index, I₂, is inversely related to molecular weight so, in other words, the use of lower molecular weight polyethylene has been observed to provide fast cycle times. In particular, a polyethylene resin with a melt index of from 2 to 10 (especially 3-8) and a narrow molecular weight distribution, Mw/Mn, of less than 3 has been found to provide a fast cycle time.

Unfortunately, conventional stabilization systems for rotomolding resins do not perform well for these easy processing/high MI resins. In particular, a conventional stabilization system which contains a primary antioxidant, a secondary antioxidant and a hindered amine light stabilizer in conventional amounts does not always provide a level of stability in these easy processing resins that is generally observed in either conventional rotomolding resins (prepared with a Ziegler catalyst) or even lower melt index rotomolding resins that are prepared with a single site catalyst.

### SUMMARY OF THE INVENTION

In one embodiment of this invention, there is provided a rotomolding process comprising
I) preparing a blend of:
   A) a polyethylene resin having:
      a) a melt index, I₂, as measured by ASTM D 1238 of from 2 to 10;
      b) a molecular weight distribution, Mw/Mn, of from 2.0 to 3.0;
      c) a density of from 0.930 to 0.950 μm;
   B) an additive package comprising:
      a) a primary antioxidant;
      b) a secondary antioxidant;
      c) at least one hindered amine light stabilizer; and
      d) from 250 to 5000 ppm of Zinc Oxide (ZnO); and
II) subjecting said blend to rototational molding.

### DETAILED DESCRIPTION OF PREFERRED EMBODIMENTS

Rotational molding technology is well known and is described in the literature. Reference may be made to U.S. Pat. No. 5,530,055 (Needham, the disclosure of which is incorporated herein by reference) for further details concerning the operation of a rotomolding process.

The rotomolding process of this invention uses a polyethylene resin that has a density of from 0.930 to 0.950 which is preferably a copolymer or inter polymer of ethylene with an alpha olefin.

In general, the term ethylene copolymer (or “interpolymer”), as used herein, is meant to refer to a copolymer of ethylene with at least one alpha olefin monomer containing from 3 to 10 carbon atoms. Thus, ethylene homopolymers are excluded but terpolymers are included. The physical properties of such ethylene copolymers are influenced by their molecular weight, molecular weight distribution, comonomer content and comonomer distribution. It is well known that the use of such comonomers produces copolymers that generally have decreased density and crystallinity as the amount of incorporated comonomer increases.

Conventional (heterogeneous) ethylene copolymers which are prepared with a conventional Ziegler-Natta catalyst generally have a comparatively broad molecular weight distribution (as defined by dividing weight average molecular weight, Mw, by number average molecular weight, Mn—i.e. molecular weight distribution equals Mw/Mn) and a broad comonomer distribution. These resins typically contain at least three distinct polymer fractions, namely a small amount (generally less than 5 weight %) of a low molecular weight, high comonomer content material (also known as “wax”); a significant fraction (15 to 25 weight %) of material having a very high molecular weight and a low comonomer content (also known as “homopolymer”); with the remainder of the copolymer being of intermediate density and molecular weight.

This lack of uniformity with respect to molecular weight and comonomer distribution has several disadvantages for example, the “wax” fraction may limit the use of these interpolymers in applications which come into contact with food and the “homopolymer” fraction is often associated with the poor impact resistance of goods made with these interpolymers. In addition, these heterogeneous polymers have a molecular weight distribution, Mw/Mn, of greater than 3.0.

In contrast, the rotomolding compositions used in this invention have a narrow molecular weight distribution. In particular the polyethylene resin of this invention must also have a molecular weight distribution Mw/Mn of from 2.0 to 3.0 (preferably from 2.2 to 2.8). Thus, preferred rotomolding compositions used in this invention are characterized by having less than 2.0 weight % of low molecular weight, high comonomer content wax (i.e. for further clarity, less than 2.0 weight % of hexane extractables as determined by the test method established by the United States Food and Drug Administration and published under CFR 177.1520 (c)) and less than 10 weight % of high molecular weight homopolymer (i.e. for further clarity, less than 10 weight % of the rotomolding composition contains less than 1 short chain branch per 1000 carbon atoms as determined by Temperature Rising Elution Fractionation or TREF).

Rotomolding compositions for use in this invention are further characterized by density and melt flow characteristics. Specifically, the density range is from 0.930 to 0.950 grams per cubic centimeter (preferably 0.935 to 0.945) and the melt index (“I₂”, as determined by ASTM D-1238, using a 2.16 kilogram load at a temperature of 190° C.) is from 2 to 10 grams per 10 minutes (preferably 3 to 8). Melt index might be regarded as an indicator of molecular weight, though an inverse relationship between the two exists. That is, as the molecular weight of the polymer increases, the flow index (I₂) decreases.

The compositions used in this invention preferably contain at least two ethylene copolymer blend components. Each of these components may be prepared by the copolymerization of ethylene with a C₄ₜₒ₂₀ alpha olefin in the presence of a catalyst system which produces homogenous polymers (i.e. as above, polymers with a narrow molecular weight distribution and narrow composition distribution). Exemplary catalyst systems include the vanadium catalyst system disclosed in U.S. Pat. No. 3,645,992 (Elston), “metallocene” catalysts (as disclosed, for example, in U.S. Pat. No. 5,324,800), “constrained geometry” catalysts (as disclosed, for example, in U.S. Pat. No. 5,064,802 Stevens et al.) and the phosphinimine catalyst systems described in the U.S. Pat. No. 6,372,864 (Brown et al.).

As previously noted, it is desirable to reduce the rotomolding cycle time so as to improve the productivity of the expensive machinery. It is further desirable to produce parts which have excellent environmental stress crack resistance; high ductility and good stiffness. This may be illustrated by considering a molded tank for liquids—the tank needs to be resistant to the elements; it should be resistant to impact (for example, it should not shatter when struck with a blunt object) and the tank needs to be stiff enough to maintain its shape when filled with liquid.

It is known to prepare rotomolded parts with a single “homogeneous” resin (i.e. a resin with a uniform comonomer distribution). Homogeneous resins do not contain the “high density” fraction which exists in conventional Ziegler Natta (“Z/N”) resins and, thus, a homogeneous resin will have a lower (and sharper) melting point than a Z/N resin of similar molecular weight and density. This, in turn may allow cycle times to be reduced using a single homogeneous resin (in comparison to the cycle time required for similar Z/N resin). However, the resulting parts are prone to warpage. In addition, the rotomolded parts prepared from homogeneous resins have poor stiffness in comparison to parts prepared from Z/N resins. The well defined melting point of the homogeneous resins used to prepare the present rotomolded parts may also assist with the fabrication of custom parts (in which thin molds with irregular shapes must be filled within tight tolerances).

The preferred blend components may be prepared as distinct polymers in separate polymerization reactions and then blended together to provide the present compositions. The blend components may be blended using conventional mixing/blending equipment such as a single or twin sinew extruder; and internal batch mixer such as a Bamburg mixer; or a continuous mixer such as a Farrel mixer. The mixing time and temperatures may be readily optimized by those skilled in the art without undue experimentation. As a guideline, mixing temperatures of from 150 to 250° C. are suitable and mixing times of 1-10 minutes may provide satisfactory results. Alternatively (and preferably), the blend components may be prepared in a multiple reactor polymerization system as disclosed in the Examples.

Typically, each blend component is a copolymer of ethylene with C₄ₜₒ₈ alpha olefin such as butene-1, pentene-1,4-methyl-1-pentene, hexene-1 or octene-1; with hexene-1 and octene-1 being most preferred.

As previously disclosed, the overall rotomolding composition of this invention has a narrow molecular weight distribution of less than 3.0. Preferred compositions are prepared with two blend components, each of which represents from 20 to 80 weight % of the total composition. It follows from these preferences that each of the two blend components preferably has a similar molecular weight as well as a narrow molecular weight distribution (i.e. in the sense that the composition would have a molecular weight distribution of greater than 3.0 if the blend components had substantially different molecular weights or if one or both of the blend components had a broad molecular weight distribution).

In addition, it is preferred that each of the blend components has essentially the same density (which, as used herein, means that the difference in density between each of the blend components is less than 0.015 grams per cubic centimeter).

The preferred rotomolding composition used in this invention preferably has a relatively sharp and low melting point in comparison to a heterogeneous resin of similar average molecular weight and density. In this sense, the present rotomolding compositions are similar to a single homogeneous resin (i.e. a single homogeneous resin will also have a relatively sharp and low melting point in comparison to a conventional heterogeneous resin of similar average molecular weight and density).

In the broadest sense, the polyethylene resin used in this invention must satisfy the following three conditions:
1) a melt index, I₂, of from 2 to 10 (preferably from 3 to 8);
2) a molecular weight distribution, Mw/Mn, of from 2.0 to 3.0 (preferably from 2.2 to 2.8); and
3) a density of from 0.930 to 0.950 g/cc.

A polyethylene resin which meets these conditions is easily processed in a rotomolding operation. However, as will be shown in the Examples, this type of resin is difficult to stabilize with a conventional additive package. In particular, this type of resin is prone to deterioration in “Weather-o-Meter” (WOM) testing.

The Weather-o-Meter™ machines are well known to those skilled in the art and are used to simulate weathering conditions. The machines are available from Atlas Electric Devices Company and may be used in accordance with various ASTM test methods.

### Additives

Rotomolding compositions conventionally contain an additive package to protect the polymer from decomposing during the processing and/or exposure to the elements and to improve processing cycle times and windows. Reference is made to “Influence of Stabilizers in Rotational Molding” (Gupta and Stadler; paper presented at 22nd Annual Fall Meeting of the Association of Rotational Molders; 5-8 Oct. 1997) for details.

The additive system of this invention includes a hindered Amine Light Stabilizers (or HALS); a secondary antioxidant that is preferably a phosphite or phosphonite (especially a diphosphite as illustrated in the examples); a “primary” antioxidant that is preferably selected from the group consisting of hindered phenols, hydroxylamines, amine oxides and lactones and zinc oxide.

The easy processing resins used in this invention deteriorate comparatively quickly in a WOM when stabilized with a conventional additive package which contains a primary antioxidant, a secondary antioxidant and a HALS. The addition of ZnO provides a surprising improvement in WOM ageing.

The additives may be incorporated into the compositions using mixing equipment such as an extruder, or internal batch mixer (also known as a banbury mixer). The additive may be added “neat” (i.e. directly to the resin); as a “masterbatch” (i.e. by premixing the additives with a small amount of polyethylene which is subsequently mixed with the bulk of the composition); or as “preblends” (i.e. mixtures of the additives). Exemplary additives are set out below.

In summary, the additive package used in the present invention must contain at least four components, namely 1) a primary antioxidant; 2) a secondary antioxidant; 3) a hindered amine light stabilizer and 4) zinc oxide.

### 1. Primary Antioxidants

As used herein, the term primary antioxidant refers to a molecule which is capable of providing free radicals with a polyethylene matrix. Preferred primary antioxidants include hindered phenols, hydroxylamines, amine oxides and lactones. A combination of more than one primary antioxidant may be used. The use of a hindered phenol or a hydroxylamine is preferred. The preferred amount of primary antioxidant is from 100 to 1000 ppm.

Exemplary primary antioxidants are described in more detail in section 1 below.

### 1.1 Alkylated Mono-Phenols

For example, 2,6-di-tert-butyl-4-methylphenol; 2-tert-butyl-4,6-dimethylphenol; 2,6-di-tert-butyl-4-ethylphenol; 2,6-di-tert-butyl-4-n-butylphenol; 2,6-di-tert-butyl-4 isobutylphenol; 2,6-dicyclopentyl-4-methylphenol; 2-(.alpha.-methylcyclohexyl)-4,6 dimethylphenol; 2,6-di-octadecyl-4-methylphenol; 2,4,6,-tricyclohexyphenol; and 2,6-di-tert-butyl-4-methoxymethylphenol.

### 1.2 Alkylated Hydroquinones

For example, 2,6di-tert-butyl-4-methoxyphenol; 2,5-di-tert-butylhydroquinone; 2,5-di-tert-amyl-hydroquinone; and 2,6diphenyl-4-octadecyloxyphenol.

### 1.3 Hydroxylated Thiodiphenyl Ethers

For example, 2,2′-thio-bis-(6-tert-butyl-4-methylphenol); 2,2′-thio-bis-(4-octylphenol); 4,4′thio-bis-(6-tertbutyl-3-methylphenol); and 4,4′-thio-bis-(6-tert-butyl-2-methylphenol).

### 1.4 Alkylidene-Bisphenols

For example, 2,2′-methylene-bis-(6-tert-butyl-4-methylphenol); 2,2′-methylene-bis-(6-tert-butyl-4-ethylphenol); 2,2′-methylene-bis-(4-methyl-6-(alpha-methylcyclohexyl)phenol); 2,2′-methylene-bis-(4-methyl-6-cyclohexylphenol); 2,2′-methylene-bis-(6-nonyl-4-methylphenol); 2,2′-methylene-bis-(6-nonyl-4-methylphenol); 2,2′-methylene-bis-(6-(alpha-methylbenzyl)-4-nonylphenol); 2,2′-methylene-bis-(6-(alpha,alpha-dimethylbenzyl)-4-nonyl-phenol); 2,2′-methylene-bis-(4,6-di-tert-butylphenol); 2,2′-ethylidene-bis-(6-tert-butyl-4-isobutylphenol); 4,4′methylene-bis-(2,6-di-tert-butylphenol); 4,4′-methylene-bis-(6-tert-butyl-2-methylphenol); 1,1-bis-(5-tert-butyl-4-hydroxy-2-methylphenol)butane 2,6-di-(3-tert-butyl-5-methyl-2-hydroxybenzyl)-4-methylphenol; 1,1,3-tris-(5-tert-butyl-4-hydroxy-2-methylphenyl)butane; 1,1-bis-(5-tert-butyl-4-hydroxy-2-methylphenyl)-3-dodecyl-mercaptobutane; ethyleneglycol-bis-(3,3,-bis-(3′-tert-butyl-4′-hydroxyphenyl)-butyrate)-di-(3-tert-butyl-4-hydroxy-5-methylpenyl)-dicyclopentadiene; di-(2-(3′-tert-butyl-2′hydroxy-5′methylbenzyl)-6-tert-butyl-4-methylphenyl)terephthalate; and other phenolics such as monoacrylate esters of bisphenols such as ethylidiene bis-2,4-di-t-butylphenol monoacrylate ester.

### 1.5 Hydroxylamines and Amine Oxides

For example, N,N-dibenzylhydroxylamine; N,N-diethylhydroxylamine; N,N-dioctylhydroxylamine; N,N-dilaurylhydroxylamine; N,N-ditetradecylhydroxylamine; N,N-dihexadecylhydroxylamine; N,N-dioctadecylhydroxylamine; N-hexadecyl-N-octadecylhydroxylam nine; N-heptadecyl-N-octadecylhydroxylamine; and N,N-dialkylhydroxylamine derived from hydrogenated tallow amine. The analogous amine oxides (as disclosed in U.S. Pat. No. 5,844,029, Prabhu et al.) are also suitable.

### 2. Secondary Antioxidants

The term secondary antioxidant refers to an additive that is used to scavenge peroxides. Examples include triphenyl phosphite; diphenylalkyl phosphates; phenyldialkyl phosphates; tris(nonyl-phenyl)phosphite; trilauryl phosphite; trioctadecyl phosphite; distearyl pentaerythritol diphosphite; tris(2,4-di-tert-butylphenyl)phosphite; diisodecyl pentaerythritol diphosphite; 2,4,6-tri-tert-butylphenyl-2-butyl-2-ethyl-1,3-propanediol phosphite; bis(2,4-di-tert-butylphenyl)pentaerythritol diphosphite tristearyl sorbitol triphosphite; and tetrakis(2,4-di-tert-butylphenyl)4,4′-biphenylene diphosphonite, phosphorous compounds (especially phosphites and phosphonites) and sulfur compounds (especially esters of betatriodipropionic acid) and dialkylsulfides. Phosphorus compounds are preferred, especially the phosphites and phosphonites. A combination of more than one secondary antioxidant may be used.

It is particularly preferred to include a diphosphite and diphosphonite as these additives may extend the “processing window” (i.e. allowing the part to remain in the mold for an extended period of time without becoming “overcooked” to the point of discoloration and/or the loss of physical properties). The preferred amount of secondary antioxidant is from 100 to 3000 ppm.

### 3. Hindered Amine Light Stabilizers

In general, a hindered amine light stabilizer (HALS) has a hindered amine functional group (which is preferably a tetramethyl piperidine group) together with an organic “structure” or “backbone” that is used to deliver the functional group to the polymer that is being stabilized. The number average molecular weight (Mn) of these HALS structures typically range from about 600 to about 15,000. HALS are well known items of commerce and are readily available from such suppliers as Ciba Specialty Chemicals and Cytec Incorporated.

Examples of HALS include bis(2,2,6,6-tetramethylpiperidyl)-sebacate; bis-5 (1,2,2,6,6-pentamethylpiperidyl)-sebacate; n-butyl-3,5-di-tert-butyl-4-hydroxybenzyl malonic acid bis(1,2,2,6,6,-pentamethylpiperidyl)ester; condensation product of 1-hydroxyethyl-2,2,6,6-tetramethyl-4-hydroxy-piperidine and succinic acid; condensation product of N,N′-(2,2,6,6-tetramethylpiperidyl)-hexamethylendiamine and 4-tert-octylamino-2,6-dichloro-1,3,5-s-triazine; tris-(2,2,6,6-tetramethylpiperidyl)-nitrilotriacetate, tetrakis-(2,2,6,6-tetramethyl-4-piperidyl)-1,2,3,4butane-tetra-arbonic acid; and 1,1′(1,2-ethanediyl)-bis-(3,3,5,5-tetramethylpiperazinone). These amines typically called HALS (Hindered Amines Light Stabilizing) include butane tetracarboxylic acid 2,2,6,6-tetramethyl piperidinol esters. Such amines include hydroxylamines derived from hindered amines, such as di(1-hydroxy-2,2,6,6-tetramethylpiperidin-4-yl) sebacate; 1-hydroxy 2,2,6,6-tetramethyl-4-benzoxypiperidine; 1-hydroxy-2,2,6,6-tetramethyl-4-(3,5-di-tert-butyl-4-hydroxy hydrocinnamoyloxy)-piperidine; and N-(1-hydroxy-2,2,6,6-tetramethyl-piperidin-4-yl)-epsiloncaprolactam.

Additional details concerning suitable HALS for use in the present invention are disclosed in U.S. Pat. Nos. 5,037,870 and 5,134,181, the disclosures of which are incorporated herein by reference. The preferred amount of HALS is from 300 to 3000 ppm.

### 4. Zinc Oxide

The use of from 250 to 5000 ppm of zinc oxide (ZnO) is essential to the present invention. ZnO is widely used as a polyolefin additive. Any of the commercially available ZnO products which are presently used in polyolefins are potentially suitable for use in the present invention. Preferred zinc oxide is prepared by the so called “French Process” and has a mean particle size of less than 1 micron. ZnO sold under the trademark “KAYDOX 911” is suitable. Representative physical properties of KAYDOX 911 ZnO are reported by the manufacturer as: a) mean particle size: 0.12 microns and b) surface area: 9.0 m²/g.

### Other Additives

### Polyamide Stabilizers

For example, copper salts in combination with iodides and/or phosphorus compounds and salts of divalent manganese.

### Basic Co-Stabilizers

For example, melamine; polyvinylpyrrolidone; dicyandiamide; triallyl cyanurate; urea derivatives; hydrazine derivatives; amines; polyamides; polyurethanes; alkali metal salts and alkaline earth metal salts of higher fatty acids, for example, Ca stearate, calcium stearoyl lactate, calcium lactate, Zn stearate, Mg stearate, Na ricinoleate and K palmitate; antimony pyrocatecholate or zinc pyrocatecholate, including neutralizers such as hydrotalcites and synthetic hydrotalcites; and Li, Na, Mg, Ca, Al hydroxy carbonates.

### Nucleating Agents

For example, 4-tert-butylbenzoic acid; adipic acid; diphenylacetic acid; sodium salt of methylene bis-2,4-dibutylphenyl; cyclic phosphate esters; sorbitol tris-benzaldehyde acetal; and sodium salt of bis(2,4-di-t-butylphenyl) phosphate or Na salt of ethylidene bis(2,4-di-t-butyl phenyl)phosphate. Nucleating agents may improve stiffness of the rotomolded part.

### Fillers and Reinforcing Agents

For example, calcium carbonate; silicates; glass fibers; asbestos; talc; kaolin; mica; barium sulfate; metal oxides and hydroxides; carbon black and graphite.

### Miscellaneous

For example, plasticizers; UV absorbers; epoxidized vegetable oils, such as epoxidized soybean oils; lubricants; emulsifiers; pigments; optical brighteners; flame proofing agents; anti-static agents; blowing agents and thiosynergists, such as dilaurythiodipropionate or distearylthiodipropionate.

Foamable rotomolded parts are also contemplated. As disclosed in U.S. Pat. No. 5,532,282 (Needham) foaming agents are useful to reduce part weight, provide a higher insulation value, increase stiffness and reduce resin cost. Generally, foaming agents may be classified as “physical” or “chemical” foaming agents. Typically, physical foaming agents are normally gaseous at the temperature at which the plastic mass is to be foamed. Chemical foaming agents are typically compositions which decompose or react to form a gas. Heat decomposable, foaming agents include organic compounds such as azodicarbonamide, 4,4′-oxybisbenzene-sulfonyl hydrazide, and p-toluenesulfonyl hydrazide; disadvantages include cost and unpleasant odor. Carbon dioxide-releasing, foaming agents include inorganic salts such as sodium, ammonium and potassium bicarbonate. A foaming coagent is advantageously used with a reactive type, chemical foaming agent, and for an acid-released foaming agent, a fatty acid such as stearic acid or a mild organic acid such as citric acid is often used as the coagent.

Useful co-additives, when foaming thermoplastics, include foam nucleating agents. A foam nucleating agent promotes uniform cell size and reduces the existence of surges and voids in the foam. Suitable foam nucleating agents include calcium carbonate; pigments such as carbon black; and silicates such as kaolins, talc, aluminum silicate, magnesium silicate and calcium silicate.

Similarly, crosslinkable rotomolded parts are contemplated. As disclosed in U.S. Pat. No. 5,367,025 (Needham) crosslinking agents may include a combination of organic peroxide initiator and a crosslinking co-agent. For rotomolding, dialkyl peroxides used include 2,5-dimethyl-2,5-di(t-butylperoxy)hexane or alpha,alpha′-bis(t-butylperoxy)diisopropylbenzene or those disclosed in U.S. Pat. No. 3,214,422. Co-agents used by those experienced in the art of crosslinking polyethylene, include triallyl cyanurate, triallyl isocyanurate, triallyl trimellitate, trimethololpropane trimethacrylate and related monomers.

### EXAMPLES

Experimental procedures are described below:

Four different types of polyethylene resin were used. Two were prepared with a conventional Ziegler Natta (Z/N) catalyst and each had a molecular weight distribution, Mw/Mn, of between 3.2 and 3.5. Conventional resin “Z/N1” also had a melt index, I₂, of 5 g/10 minutes and a density of 0.935 g/cc. Conventional resin “Z/N2” had a melt index, I₂, of 1.8 g/10 minutes and a density of 0.942 g/cc.

Two “single site catalyst” (SSC) resins were also used. Each of SSC1 and SSC2 resin had a molecular weight distribution, Mw/Mn, of between 2.2 and 2.8. SSC1 had a melt index, I₂, of 5 g/10 minutes and a density of 0.939 g/cc. SSC2 had a melt index, I₂, of 1.7 g/10 minutes and a density of 0.944 g/cc.

The resins were blended with the additive packages described in Table 1 and ground into fine powder for the preparation of rotomolded parts. For clarification: the compounded resin used in experiment 1 was conventional polyethylene ZN1 and contained 300 ppm of primary antioxidant (Lowinox™ 1790); 1500 ppm of secondary antioxidant (Irgafos 168) and 2200 ppm of HALS (Cyasorb UV3346).

Also for clarity: the composition of experiment 3 contained 500 ppm of primary antioxidant 1; 250 ppm of primary antioxidant 2; 800 ppm of secondary antioxidant 1 and 500 ppm of secondary antioxidant 2.

Rotomolded parts were then prepared in a rotational molding machine sold under the tradename Rotospeed RS3-160 by Ferry Industries Inc. The machine has two arms which rotate about a central axis. Each arm is fitted with a plate which rotates on an axis that is roughly perpendicular to the axis of rotation of the arm. Each plate is fitted with three cast aluminum molds that produce plastic cubes having dimensions of 12.5 inches (31.8 cm)×12.5 inches×12.5 inches. These molds produce parts having a nominal thickness of about 0.25 inches (0.64 cm) when initially filled with a standard charge of about 3.7 kg of polyethylene resin.

A gas fired furnace which is capable of providing 2 million British thermal units (Btu) per hour is used to provide hot air that is circulated about the molds by a fan. The temperature within the enclosed oven is maintained at a temperature of between 520° F. (271° C.) and 600° F. (316° C.) for specified periods of time while the machine rotates the arms (typically, at about 8 revolutions per minute (rpm) and the plate (typically, at about 2 rpm).

The “cooked parts” are then cooled by opening the oven. Water spray may also be used to facilitate cooling. “Cook times”, rotation speed, temperatures and cooling cycles are computer controlled with appropriate software which also includes a data acquisition system.

Physical properties of the polyethylene resins and/or specimens cut from the molded cubes were measured using the following standard test methods:

Melt Index (I₂) was measured according to ASTM D 1238 at 230° C. using a 2.16 kg load.

Tensile strength was measured using an Instron machine.

Samples from the molded parts were placed in the Weather-o-Meter (WOM) and subjected to heat and light to simulate weathering conditions. The tensile strength of the samples was measured prior to being placed in the WOM. Samples were withdrawn from the WOM at regular intervals and tensile strength was again determined. The testing was stopped when the measured tensile value was less than 50% of the original value. For example, experiment ZN1 retained more than 50% elongation at 11,000 hours in the WOM. The next test was conducted at 15,000, at which time the tensile value had fallen to below 50% of the original value—so this test result is shown as >11,000 hrs., <15,000 hrs. The results in Table 1 show that both conventional Z/N resins were well stabilized by a “conventional” additive package (experiments 1 and 2).

In addition, the SSC resin with a 1.7 MI was also well stabilized by a conventional additive package (experiment 4). However, the SSC resin with <5 MI failed at between 2000 and 4000 WOM hours (experiment 3). In contrast, the inventive compositions (with ZnO) perform much better in WOM testing (experiments 6-8).

Many additional rotomolded “cubes” were prepared as described above using additive packages substantially as shown in Table 1. Some warpage/deflection was observed, particularly when 500 ppm of additive P2 was employed. Additional cubes were then prepared using lower amounts of P2 (250 ppm); 550 ppm of S1; 450 ppm of S2; 750 ppm of H3; 750 ppm of H2; and 750 ppm of zinc oxide. This additive package was observed to provide cubes with a lower level/occurrence of deflections.

TABLE 1

| | | Additives | | | | | | | WOM Exposure |
|---|---|---|---|---|---|---|---|---|---|
| | | Primary | | Secondary | | HALS | | ZnO | Time to <50% |
| Experiment | Resin | Type | Amounts | Type | Amounts | Type | Amounts | Level | Intial Elongation h |
| 1 | ZN1 | P1 | 300 | S1 | 1500 | H1 | 2200 | — | >11000, <15000 |
| 2 | ZN2 | P1 | 300 | S1 | 1500 | H1 | 2200 | — | >15000, (15000 h was end of test) |
| 3 | SSC1 | P2/3 | 500/250 | S1/2 | 800/500 | H1 | 2200 | — | >2000, <6000 |
| 4 | SSC2 | P2/3 | 500/250 | S1/2 | 800/500 | H1 | 2200 | — | >11000, <15000 |
| 5 | SSC1 | P2 | 500 | S1/2 | 800/500 | H2/H3 | 2000/500 | — | >2000, <4000 |
| 6 | SSC1 | P2 | 500 | S1/2 | 800/500 | H2 | 1500/0 | 500 | >8000, <11000 |
| 7 | SSC1 | P2 | 500 | S1/2 | 800/500 | H2 | 1500/0 | 1000 | >15000, (15000 h was end of test) |
| 8 | SSC1 | P2 | 500 | S1/2 | 800/500 | H2/H3 | 1250/1250 | 500 | >15000, (15000 h was end of test) |

Resin MI Values: ZN1 = 5; ZN2 = 1.8; SSC1 = 5; SSC2 = 1.7 (all g/10 minutes)
P1 = hindered phenol sold as Lowinox ™ 1790 by Chemtura Corporation
P2 = hydroxyl amine sold as IRGASTAB ™ FS042 by Ciba
P3 = hindered phenol sold as IRGANOX ™ 1076 by Ciba
S1 = phosphite sold as IRGAFOS ™ 168 by Ciba
S2 = diphosphite sold as DOVERPHOS ™ 9228-S by Dover Chemicals
H1 = HALS sold as CYASORB ™ UV3346 by Cytec
H2 = HALS sold as CHIMASSORB ™ 944 by Ciba
H3 = HALS sold as TINUVIN ™ 622 by Ciba

What is claimed is:

1. A rotomolding process comprising
I) preparing a blend of:
A) a polyethylene resin having:
i) a melt index, I₂, as measured by ASTM D 1238 of from 2 to 10;
ii) a molecular weight distribution, Mw/Mn, of from 2.0 to 3.0;
iii) a density of from 0.930 to 0.950 g/cc;
B) an additive package comprising:
a) a primary antioxidant;
b) a secondary antioxidant;
c) at least one hindered amine light stabilizer; and
d) from 250 to 3000 ppm of ZnO; and
II) Subjecting said blend to rototational molding.

2. The process of claim 1 wherein said polyethylene resin is a blend of more than one polyethylene blend component.

3. The process of claim 2 wherein said polyethylene resin has a Mw/Mn of from 2.2 to 2.8.

4. The process of claim 1 wherein
a) said primary antioxidant is selected from the group consisting of hindered phenols and hydroxylamines; and
b) said secondary antioxidant is selected from the group consisting of phosphites phosphonites.

5. The process of claim 4 wherein said phosphite is a combination of a monophosphite and a diphosphite.
